(19) United States
(12) Patent Application Publication
(10) Pub. No.: US 2008/0010624 A1
(43) Pub. Date: Jan. 10, 2008

(54) Object-oriented layout data model and integrated circuit layout method using the same

(76) Inventors: Po Huang Lin, Hsinchu City (TW); Yi Jen Su, Hsinchu City (TW); Miin Chih Shih, Hsinchu City (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/481,182

(22) Filed: Jul. 6, 2006

(51) Int. Cl. G06F 17/50

(52) U.S. Cl. 716/10; 716/2

(57) ABSTRACT

An integrated circuit layout method directly extracts plural primitive objects from a user's existing layout to expedite a new layout for reuse and migration and to gain the benefits of full coverage and minimal cost of layout design. The integrated circuit layout method comprises the steps of capturing a set of design parameters from a user's existing layout; capturing a plurality of primitive objects from the user's existing layout; extracting at least one leaf device from the user's existing layout; defining at least one nested device based on the leaf device; setting compaction constraints for the nested device to form a basic layout; and performing a layout task based on the basic layout. In addition, an object-oriented layout data model, used in the aforesaid integrated circuit layout method, comprises a first set of fields storing layer usages of plural layers captured from a user's existing layout to define a primitive object, a second set of field storing a set of design parameters regarding the layers, and a third set of fields defining plural data types of the first and the second sets of fields.

### BACKGROUND OF THE INVENTION

1. Field of the Invention

The present invention relates to an object-oriented layout data model and an integrated circuit layout method using the same, and more particularly to an object-oriented layout data model and an integrated circuit layout method using the same, which allow for layout reuse and layout migration.

2. Description of the Related Art

Semiconductor circuits or chips have become widely used in articles for daily use. A typical electronic circuit design is initially conceived and tested schematically by a circuit design engineer, with a number of components and devices connected to generate a circuit with desired performance characteristics. Once the circuit has been designed, it must be reconfigured from the schematic form into a geometric layout form. This is typically a job for a physical design engineer, working in concert with a circuit design engineer to create a graphic layout specifying a suitable semiconductor implementation of the circuit. The geometric layout of the device, which specifies all of the semiconductor device layout parameters, is then submitted to a foundry for fabrication of the chip.

Configuring the geometric layout from the schematic form for an electronic circuit is a very complicated task, and is governed by a large number of geometric rules. A geometric layout of a semiconductor device contains geometric features such as polygons to indicate the proper size, shape, location and separation of a certain physical feature of the circuit, distinguishing it from other physical features, or to indicate proper isolation and separation among the circuit elements. The geometric layout of a typical semiconductor device contains multiple layers, each layer having one or more polygons. Generally, the more complicated the device is, the more layers and polygons the layout includes.

In addition, to lay out another semiconductor device, the circuit design engineer and the physical design engineer have to restart the complicated task. Even the circuit design of the semiconductor device will be fabricated by a new fabrication process rather than a predetermined process; the circuit design engineer and the physical design engineer have to modify the parameters of the circuit layout to meet constraints of the new fabrication process, which is time-consuming and error-prone. In other words, the prior art consumes a lot of effort when the existing layout is re-used or migrated to a different fabrication process.

In some traditional layout methods available in the current market, the coverage of the layout method provided is limited, because only some specific layout patterns are supported, which are developed from the view of a programmer, not from the view of a user. Therefore, the prior arts cannot provide more flexible design tools to satisfy the user's requirement.

### SUMMARY OF THE INVENTION

The objective of the present invention is to provide an object-oriented layout data model and an integrated circuit layout method using the same, by directly extracting plural primitive objects from a user's existing layout, to expedite a new layout for reuse and migration and to gain the benefits of full coverage and minimal cost of layout design.

In order to achieve the objective, the present invention discloses an integrated circuit layout method utilizing an object-oriented layout data model, the integrated circuit layout method comprising: (a) extracting at least one leaf device from a user's existing layout; (b) defining at least one nested device based on the leaf device; (c) setting compaction constraints for the nested device to form a basic layout; and (d) performing a layout task based on the basic layout. The user's existing layout is always workable, because it was used in the user's previous design and proven to function. Thus the leaf devices extracted directly from the user's existing layout are ready to be used in the next new design. Also, the nested device is defined by the leaf devices, and is workable and ready to be used. The integrated circuit layout method of the present invention further comprises the step of capturing a set of design parameters from the user's existing layout, which is before Step (a). The step of capturing the set of design parameters comprises: capturing a set of design rules and a set of design constraints, which are both modifiable by a user; and saving the set of design rules and the set of design constraints. The set of design parameters, which is dimension-related and position-related, is also modifiable at Step (c). The integrated circuit layout method of the present invention further comprises the step of capturing a plurality of primitive objects from the user's existing layout, which comprises: defining a layer usage of each layer captured from the user's existing layout; identifying the primitive objects according to the layer usages; and saving the primitive objects. The layout task is selected from the group consisting of optimization, Engineer Change Order (ECO), reuse, porting and migration. In three embodiments of the object-oriented layout data model of the present invention, the primitive objects are CUT object, GATE object and PATH object, respectively, which will be explained in detail below.

As for the object-oriented layout data model, it is used in the integrated circuit layout method and comprises: a first set of fields storing the layer usages of plural layers captured from the user's existing layout to define a primitive object; a second set of fields storing a set of design parameters regarding the layers; and a third set of fields defining plural data types of the first and the second sets of fields. Different combinations of the contents of the first set of fields define different primitive objects.

### BRIEF DESCRIPTION OF THE DRAWINGS

The invention will be described according to the appended drawings in which:

FIGS. 1(a) through 1(c) show some process layer information of a technology file;

FIG. 2 illustrates the structure of the object-oriented layout data model of the present invention;

FIGS. 3(a) through 3(f) illustrate some design parameters;

FIG. 4(a) shows the layout of the second embodiment of the object-oriented layout data model of the present invention;

FIG. 4(b) shows the layout of the third embodiment of the object-oriented layout data model of the present invention;

FIG. 5 shows the flow chart of the first embodiment of the integrated circuit layout method of the present invention;

FIGS. 6(a) and 6(b) illustrate a primitive object with design parameters changed before and after; and

FIG. 7 illustrates a nested device comprising four leaf devices and four connecting wires.

### PREFERRED EMBODIMENT OF THE PRESENT INVENTION

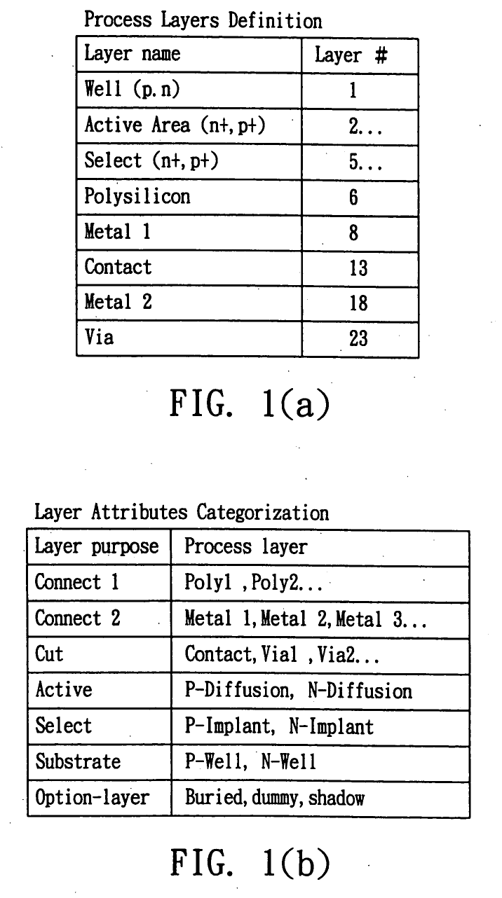

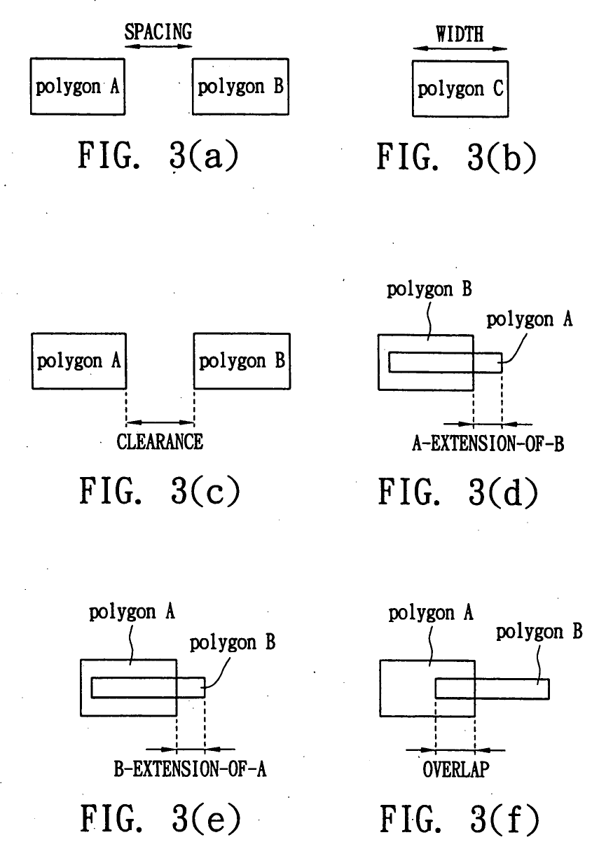

FIGS. 1(a) through 1(c) show some process layer information of a technology file. FIG. 1(a) shows process layers definition of the technology file, which only display two columns, the layer name and layer number thereof. The integrated circuit layout method of the present method categorizes the process layers based on the purpose of each process layer, such as the composition or function of the layer, into several layer classes (i.e., Connect 1, Connect 2, Cut, etc.), as shown in FIG. 1(b). For example, the layers “Poly 1” and “Poly 2” are categorized in the class “Connect 1” in FIG. 1(b). The Boolean operation can then be used to identify the basic structure such as gate or via based on the combination of layers belonging to different classes. For example, poly (i.e., connect 1) & active=gate, as shown in the second row of FIG. 1(c) (also refer to FIG. 4(a)).

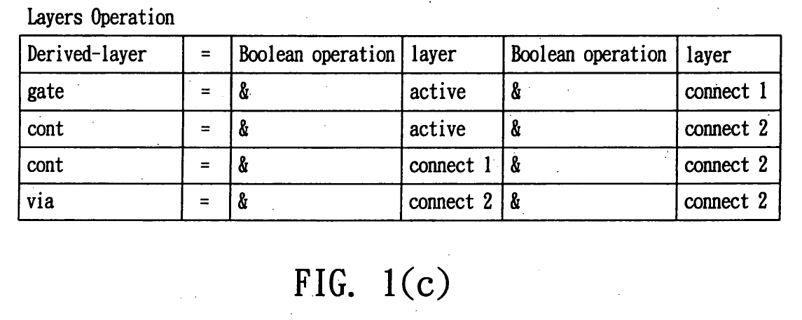

The object-oriented layout data model of the present invention is described as follows. Referring to FIG. 2, the object-oriented layout data model 2 comprises a first set of fields 21, a second set of fields 22 and a third set of fields 23. The first set of fields 21 contains plural fields F11, F12, etc., and F1p. The second set of fields 22 contains plural fields F21, F22, etc., and F2q. The third set of fields contains plural fields F31, F32, etc., and F3r. Each of p, q and r is a positive integer. The number of the fields in each set can be dynamically and independently adjusted during operation.

The first set of fields 21 is used to store the layer usages of plural layers captured from the user's existing layout that has been proven to be workable. The layer usages of the layers are used to define a primitive object. A user can capture the layers from the user's existing layout and identify the layer usages thereof to form a primitive object for reuse.

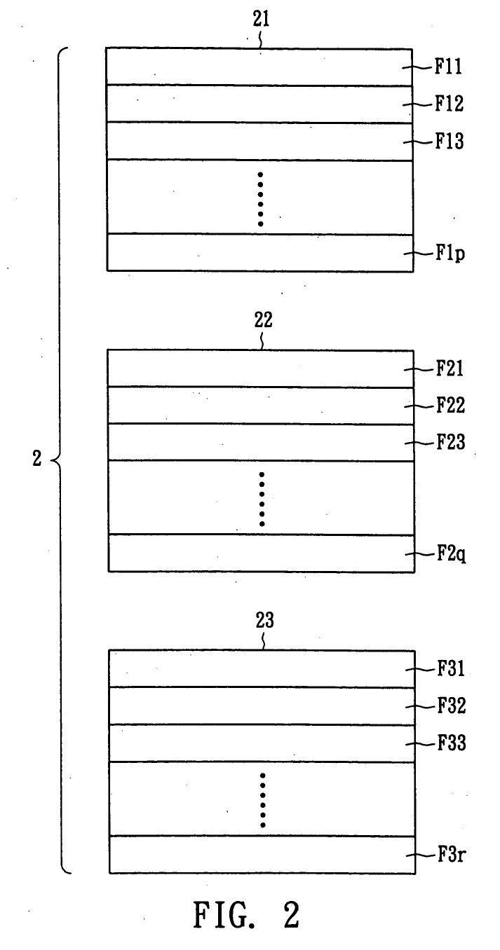

The second set of fields 22 is used to store the set of design parameters. Some design parameters are shown in FIGS. 3(a) through 3(f). The set of design parameters contains a set of design rules (e.g., WIDTH of the polygon, SPACING between two adjacent intra-layer polygons, CLEARANCE between two interlayer polygons, OVERLAP between two interlayer polygons, A-EXTENSION-OF-B and B-EXTENSION-OF-A of two interlayer polygons), a set of design constraints (e.g., the width and length of a gate of a MOS device) and a set of user constraints (e.g., die aspect ratio). The set of design parameters further comprises two parameters of Repetition and Justification. Repetition represents the number of duplications of the primitive object, and Justification represents the alignment of the primitive object.

The third set of fields 23 is used to define plural data types of the first and the second sets of fields. The data types comprise: LayerName type defining the layer name of the layer captured from the user's existing layout, which is modifiable by the user; Number type defining the values used in the set of design parameters, which is not modifiable by the user; Keyword type defining a maximal value or a minimal value used in the set of design parameters; and Variable type defining a middle value between the maximal value and the minimal value, which is modifiable and used in the set of design parameters. The primitive object is a point object, which means the primitive object can be directly dragged by a mouse to a specific location in a circuit layout and some geometrical features thereof, such as the dimension, the relative position with respect to other primitive objects, can just be modified by adjusting the set of design parameters. When the primitive objects are used, the user does not need to draw from a line or a polygon, step by step, to build up an elementary device that can perform some circuit functions.

In the first embodiment of the object-oriented layout data model, the primitive object is called a PATH object, in which the first set of fields 21 comprises: a type field storing the type of the primitive object, which is determined by the content of the layer1 field; a layer1 field storing the layer usage of a first layer; and a region1 field storing the layer usage of Select, wherein Select represents the layer of P-implant or N-implant (refer to FIG. 1(b)). In the current embodiment, the first layer is Metal, Poly or Active, wherein Metal represents the layer of Metal1, Metal2 or Metal3; Poly represents the layer of Poly1 or Poly2; and Active represents the layer of P-diffusion or N-diffusion. The type of the PATH object, stored in the type field, is determined by the content of the layer1 field. If the layer1 field is Metal, Poly or Active, the type of the PATH object is treated as Metal, Poly or Diffusion, respectively.

In the second embodiment of the object-oriented layout data model, the primitive object is called a GATE object, in which the first set of fields 21 comprises: a type field storing the type of the primitive object which is determined by the layer1 field and the layer2 field; a layer1 field storing the layer usage of a first layer; a layer2 field storing the layer usage of a second layer; and a region1 field storing the layer usage of Select, wherein Select represents the layer of P-implant or N-implant (refer to FIG. 1(b)). In the current embodiment, the first layer is Poly and the second layer is Active, wherein Poly represents the layer of Poly1 or Poly2; and Active represents the layer of P-diffusion or N-diffusion. The type of the GATE object, stored in the type field, is determined by the contents of the layer1 field and the layer2 field. There is only one combination of the layer1 field (i.e., Poly) and the layer2 field (i.e., Active), which form the GATE object of Poly type (refer to FIG. 4(a)).

In the third embodiment of the object-oriented layout data model, the primitive object is called a CUT object, in which the first set of fields 21 comprises the same structure of the second embodiment except that the first layer is Metal and the second layer is Metal, Poly or Active, wherein Metal represents the layer of Metal1, Metal2 or Metal3; Poly represents the layer of Poly1 or Poly2; and Active represents the layer of P-diffusion or N-diffusion. The type of the CUT object, stored in the type field, is determined by the contents of the layer1 field and the layer2 field. Referring to FIG. 4(b), if the first layer is Metal and the second layer is Metal, Poly or Active, the type of the CUT object is treated as Via, Diffusion or Contact, respectively.

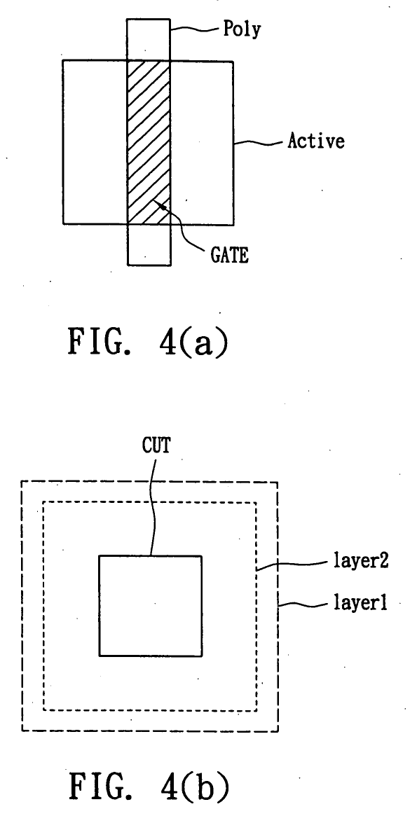

FIG. 5 shows the flow chart of the first embodiment of the integrated circuit layout method of the present invention. First, the user captures a set of design parameters from the user's existing layout (S32). The set of design parameters comprises a set of design rules and a set of design constraints, which are modifiable by the user and saved into the second set of fields 22 (refer to FIG. 2) for reuse. The sets of design rules and design constraints can be modified at this step or later. At the same time, the user can capture a plurality of primitive objects from the user's existing layout (S33). The step of capturing the primitive objects from the user's existing layout comprises the steps of: (1) defining a layer usage of each layer captured from the user's existing layout, wherein the layer usage such as Active, Poly or Metal is commonly used in the field of circuit layout; (2) identifying the primitive objects according to the layer usages, wherein the layer usages are stored in the layer1 field and the layer2 field of the first set of fields 21, and the identified primitive objects comprise the CUT object, the GATE object and the PATH object; and (3) saving the primitive objects into a knowledge base for reuse.

After Step S33, the user extracts at least one leaf device from the user's existing layout (S34). That is, the user first sets a region of selection, and then extracts a leaf device covered by the region based on the primitive objects. Before the leaf device is finalized, the user can add additional polygons or objects to the leaf device. Finally, the leaf device is used to replace the current layout. The leaf device could be a PMOS device, an NMOS device, a CMOS device, an inverter, a buffer or any elementary device practicing at least one function. All the leaf devices extracted from the user's existing layout are workable and ready to use in the next new design. After that, the user defines at least one nested device based on the leaf device (S35). That is, the user connects some leaf devices and polygons to form a nested device. For example, a PMOS device can be connected to an NMOS device to form a CMOS inverter. The CMOS inverter is called a nested device that exhibits one level higher than the leaf device. Then, the nested device is used to replace the current layout. The leaf and the nested devices can be named the first-level and the second-level devices, respectively, and both of them are saved into the knowledge base. In practice, the user can build higher-level (more complicated) devices for reuse, according to the knowledge base. In addition, the user can assign some reference lines and user constraints (e.g., die aspect ratio and fixed distance between two adjacent nested devices) against the reference lines. The user constraints are stored in the second set of fields 22 (refer to FIG. 2), which stores the set of design rules and the set of design constraints.

After Step S35, the step of setting compaction constraints for the nested devices is performed to form a basic layout (S36). The compaction constraints comprise: (1) a set of design constraints such as match pattern (asymmetry or symmetry) and inter-digitations patterns for array (common axis or centroid); (2) a set of design rules; and (3) a set of user constraints such as die aspect ratio and fixed distance between two adjacent nested devices. When the user adjusts the values of the compaction constraints, the corresponding dimensions, positions, and shapes of the primitive objects change accordingly without breaking the hierarchy of the building blocks (i.e., the primitive objects, the leaf devices, the nested devices and the higher-level devices). So far, the basic layout is formed, which contains many building blocks extracted from the user's existing layout and the knowledge base. The leaf devices, nested devices and higher-level devices, which are constructed based on the primitive objects, inherit the feature of the primitive object, e.g., a point object.

After that, a layout task is performed based on the basic layout (S37). The layout task is selected from the group consisting of optimization, ECO, reuse, porting and migration. A brief explanation about the layout task is given below. For optimization, the user adjusts the values of the set of design parameters to compact a rough and loose preliminary layout into the smallest possible area. For ECO, the user adjusts the values of the width, the length, Repetition, Stepping Distance, etc., to modify the layout because of small changes to the functionality of a design, or to fix errors. For reuse, the user can create a new layout by adjusting some dimensions of an existing layout. For porting, the user adjusts the layout according to a new set of design rules by another foundry. For migration, the user adjusts the layout according to a new set of design rules for the new generation of process.

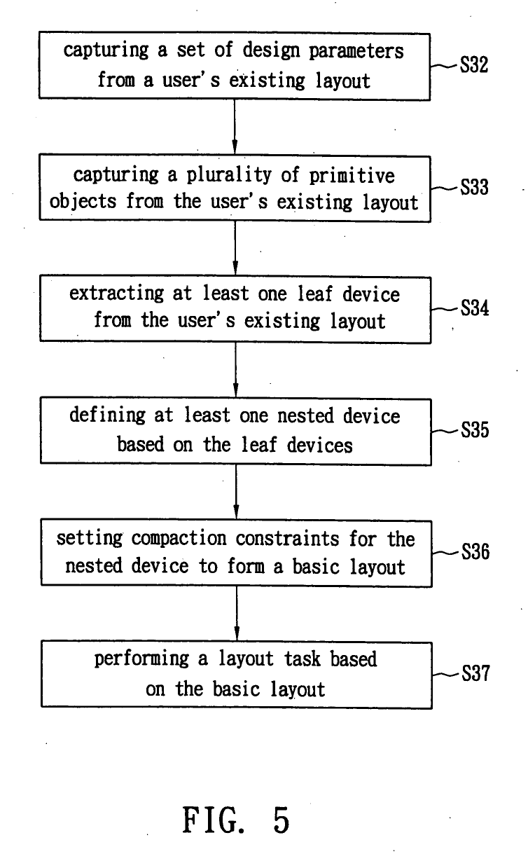

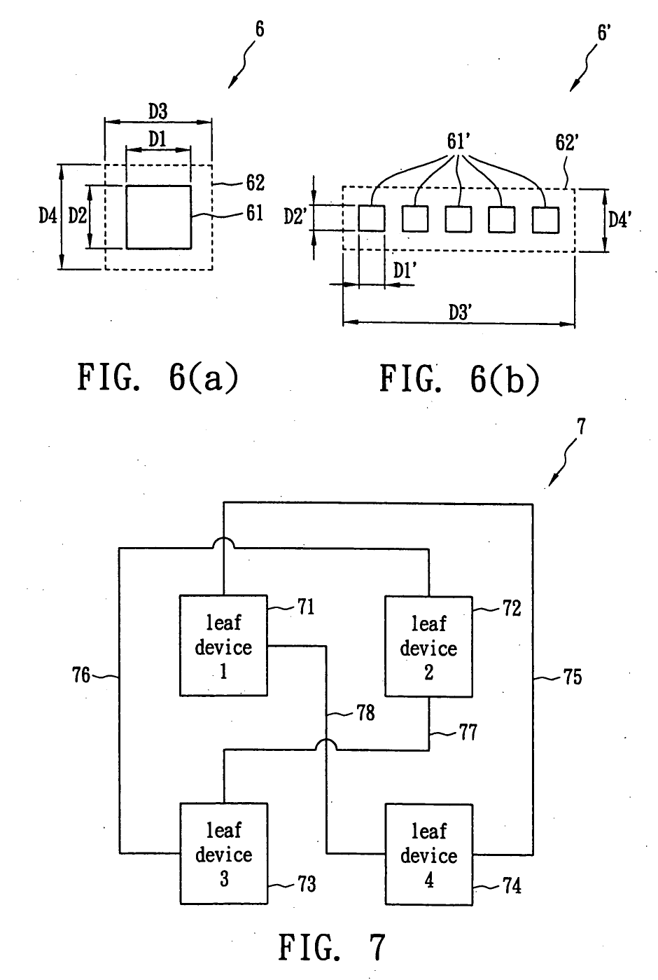

FIGS. 6(a) and 6(b) illustrate a primitive object with design parameters changed before and after. In FIG. 6(a), the primitive object 6 with the dimensions D1, D2, D3 and D4 of layers 61, 62 is modified to the primitive object 6′ with the dimensions D1′, D2′, D3′ and D4′ of layers 61′, 62′ in FIG. 6(b), which is treated by a shrinking operation with the value of Repetition equal to five. FIG. 7 illustrates a nested device 7 constructed by four connecting wires 75, 76, 77 and 78, and four leaf devices 71, 72, 73 and 74. Each of the leaf devices 71, 72, 73 and 74 comprises one or more primitive objects 6 or 6′. In the same way, the user can build a more complicated layout using the integrated circuit layout method, which allows for quick, accurate, efficient modification for reuse without breaking the hierarchy of the building blocks.

A layout generated by the integrated circuit layout method of the present invention is called an extraction-based object layout. If the user's existing layout is already the extraction-based object layout, which means it was generated by the present method before, and currently needs modifying for optimization, ECO, reuse, porting or migration, accordingly the second embodiment of the integrated circuit layout method of the present invention is proposed, which only comprises the steps of S34, S35, S36 and S37 of FIG. 5. Because the building blocks (i.e., the primitive objects, leaf device, nested device and higher-level devices) are currently available in the user's existing layout, the user can extract them directly and modify the values of the design parameters according to the steps of S34-S37 to generate a new layout.

The above-described embodiments of the present invention are intended to be illustrative only. Numerous alternative embodiments may be devised by persons skilled in the art without departing from the scope of the following claims.

What is claimed is:

1. An integrated circuit layout method utilizing an object-oriented layout data model and comprising the steps of:
(a) extracting at least one leaf device from a user's existing layout;
(b) defining at least one nested device based on the leaf device;
(c) setting compaction constraints for the nested device to form a basic layout; and
(d) performing a layout task based on the basic layout.

2. The integrated circuit layout method of claim 1, further comprising the step of capturing a set of design parameters from the user's existing layout before the step (a).

3. The integrated circuit layout method of claim 2, wherein the step of capturing a set of design parameters from the user's existing layout comprises:
capturing a set of design rules and a set of design constraints, which are modifiable; and
saving the set of design rules and the set of design constraints.

4. The integrated circuit layout method of claim 1, further comprising the step of capturing a plurality of primitive objects from the user's existing layout before the step (a).

5. The integrated circuit layout method of claim 1, wherein the step of capturing a plurality of primitive objects from the user's existing layout comprises the steps of:
defining a layer usage of each layer captured from the user's existing layout;
identifying the primitive objects according to the layer usages; and
saving the primitive objects.

6. The integrated circuit layout method of claim 1, wherein the compaction constraints comprise a set of design constraints, a set of user constraints and a set of design rules.

7. The integrated circuit layout method of claim 2, wherein the set of design parameters is dimension-related or position-related.

8. The integrated circuit layout method of claim 1, wherein the layout task is selected from the group consisting of optimization, Engineer Change Order (ECO), reuse, porting and migration.

9. The integrated circuit layout method of claim 4, wherein the primitive objects include a CUT object related to via or contact, a GATE object related to poly layer and implantation, and a PATH object related to metal layer, poly layer and the type of diffusion.

10. An object-oriented layout data model, used in an integrated circuit layout method, comprising:
a first set of fields storing layer usages of plural layers captured from a user's existing layout to define a primitive object;
a second set of fields storing a set of design parameters regarding the layers; and
a third set of fields defining plural data types of the first and the second sets of fields.

11. The object-oriented layout data model of claim 10, wherein the set of design parameters comprises a set of design rules, a set of design constraints and a set of user constraints.

12. The object-oriented layout data model of claim 11, wherein the set of design parameters further comprises the number of duplications of the primitive object and the alignment of the primitive object.

13. The object-oriented layout data model of claim 10, wherein the first set of fields comprises:
a first layer field storing the layer usage of a first layer;
a first region field storing the layer usage of a layer of P-implant or N-implant; and
a type field storing the type of the primitive object determined by the first layer field.

14. The object-oriented layout data model of claim 13, wherein the first layer is Metal related metal layer, Poly related poly layer, or Active related to the type of diffusion.

15. The object-oriented layout data model of claim 10, wherein the first set of fields comprises:
a first layer field storing the layer usage of a first layer;
a second layer field storing the layer usage of a second layer;
a first region field storing the layer usage of a layer of P-implant or N-implant; and
a type field storing the type of the primitive object determined by the first layer field and the second layer field.

16. The object-oriented layout data model of claim 15, wherein the first layer is Poly related poly layer, and the second layer is Active related to the type of diffusion.

17. The object-oriented layout data model of claim 15, wherein the first layer is Metal related metal layer, and the second layer is Metal related metal layer, Poly related to poly layer or Active related the type of diffusion.

18. The object-oriented layout data model of claim 10, wherein the data types comprise:
a first data type defining a layer name of each of the layers;
a second data type defining values used in the set of design parameters;
a third data type defining a maximal value or a minimal value used in the set of design parameters; and
a fourth data type defining a middle value between the maximal value and the minimal value.

19. The object-oriented layout data model of claim 10, wherein the primitive object is a point object.
